(19) United States
(12) Patent Application Publication
(10) Pub. No.: US 2004/0264409 A1
(43) Pub. Date: Dec. 30, 2004

(54) Resource reservation system and method in wireless mobile environments

(75) Inventors: Sung-hyuck Lee, Daegu (KR); Jong-ho Bang, Suwon-si (KR); Se-jong Oh, Anyang-si (KR); Ji-hoon Lee, Chongju-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/875,300

(22) Filed: Jun. 25, 2004

(30) Foreign Application Priority Data
Jun. 26, 2003 (KR) 10-2003-0042062

(51) Int. Cl. H04L 12/56

(52) U.S. Cl. 370/329

(57) ABSTRACT

A resource reservation system for mobile network environments having a mobile node, routers for intermediating communications between the mobile node and a correspondent node belonging to another network, and neighboring routers geographically adjacent to the router, includes a manager for sending a path request message for establishing a new path to the neighboring routers if a fast resource reservation and release (FREE) initiation message is received from the mobile node if the mobile node as a receiver performs a handoff. If the mobile node enters a communication range of any of the neighboring routers, the manager establishes a new path between the mobile node and the manager through the neighboring router for the communication range according to the sent path request message. Accordingly, the manager performs establishment of a new RSVP path and release of a previous RSVP path at the same time to prevent double resource reservation occasions.

### CROSS-REFERENCE TO RELATED APPLICATIONS

This application claims the benefit of Korean Patent Application No. 10-2003-0042062, dated Jun. 26, 2003, in the Korean Intellectual Property Office, the disclosure of which is incorporated herein by reference.

### BACKGROUND OF THE INVENTION

1. Field of the Invention

Systems and methods consistent with the present invention relate to a resource reservation system and method for effectively using resources in wireless mobile environments, and more particularly to a resource reservation system and method for solving a double resource reservation problem and a resource-wasting problem occurring due to advance resource reservations in wireless mobile environments.

2. Description of the Related Art

The types of wireless internet can be mainly classified into a wireless stationary internet type such as wireless LAN, B-WLL, Local Multipoint Distribution Service (LMDS), and Bluetooth, which highly limit mobility with transmission capacity and speed being predominant, and a wireless mobile internet type that provides high mobility with transmission capacity and speed being limited and accepts different types of systems depending upon mobile communication networks.

With the developments of mobile communication networks, the wireless mobile internet ranges from the earliest specification such as the Cellular Digital Packet Data (CDPD) using the first-generation Advanced Mobile Phone Service (AMPS) to wireless application protocol specifications such as the Wireless Application Protocol (WAP), Mobile Explorer (ME), I-mode, and so on, based on the second-generation and 2.5^{th} generation IS-95/GSM networks. Further, currently, the standardization is progressing step by step for ALL IP mobile networks based on the third-generation mobile communication system, IMT-2000, and it is expected that the mobile network would gradually become an IP-based wireless network in real life.

Currently, the ALL IP mobile network is a next-generation mobile communication network that attracts lots of attention worldwide, and the specification standardization for the network is being processed under the third-generation partnership project (3GPP) of Northern Europe and under the third-generation partnership project2 (3GPP2) of North America. Lots of technical issues for the standardization have emerged from academic groups and various forums, and diverse consortia have been organized by world-famous mobile communication network providers, manufacturers who develop network components including terminals, Internet Service Providers (ISPs) providing new services for the internet, makers for IP packet network components, and so on, to foster the standardization and developments.

The mobile IP (MIP) is used for supporting mobility in the ALL IP-implemented mobile network environments and, further, Quality of Service (QoS) is needed for guaranteeing reliable data and multimedia traffic transmissions. The scheme for reserving network resources in advance is primarily used for supporting reliable multimedia traffic transmissions, for which the Resource Reservation Protocol (RSVP) is mainly used. However, the current RSVP has not been created under consideration of mobile environments, so that appropriate resource reservations cannot be established if the mobile protocol, MIP, is employed.

Research has progressed for resource reservations in mobile environments since the emergence of the MIP, and there exists Mobile RSVP (MRSVP), RSVP Mobility Proxy (RSVP-MP), a method of Concatenation and Optimization for resource Reservation Path (CORP), and so on, as typical protocols.

FIG. 1 is a view for showing paths for pre-establishing resources according to the conventional MRSVP. The MRSVP classifies the resource reservations into a passive reservation state and an active reservation state. The passive reservation state refers to a state reserving resources in advance but not using the resources, and the active reservation state refers to a state using reserved resources. A mobile node (MN) changes its state from the passive reservation state to the active reservation state, and a proxy agent is provided in an access router to manage the state changes. The mobile node MN frequently moves its location and changes its own network access location. Further, the proxy agent manages cells adjacent to a cell in which the mobile node MN is positioned, and participates in a multicast RSVP session in advance through a particular reservation method not actually transmitting traffic.

Referring to FIG. 1, the mobile node MN establishes a communication session with a correspondent node (CN) through a path 1. When a handoff occurs, the mobile node MN sends a Spec message to neighboring proxy agents. The Spec message may include a flow specification, a flow identification, and so on, for the mobile node MN to send to a remote proxy agent. The passive reservation state is established between a proxy agent and a correspondent node between which a communication session is not set up. If the mobile node MN moves, the corresponding passive reservation state changes into the active reservation state, through which traffic is sent so that a reservation path is extended.

In the meantime, the MRSVP solves the time-delay problem for QoS re-establishments, but wastes resources in an Access Network (AN) since resources of its neighboring cells to which a terminal approaches are reserved in advance in resource-insufficient mobile network environments. Further, the mobile node MN must maintain a mobility specification including information on all neighboring locations to which it moves, during its communication session with a correspondent node. Furthermore, an intermediate router manages all state information on the passive reservation state so that unnecessary overhead occurs, which causes a problem of scalability limits when implemented. Moreover, the MRSVP does not rapidly release the communication session as to the resources established for a previous cell even when the mobile node MN moves so that it maintains a double reservation for the same communication session, which results in wasting resources. Frequent handoffs in the environments with such double resource reservations causes interference with resource use for new communication sessions.

FIG. 2 is a view for showing a path for establishing new resources through an address translation method based on the conventional RSVP-MP. The RSVP-MP is a scheme used in combination with the hierarchical mobility management scheme of MIP, and has an RSVP-MP agent located in a Mobility Anchor point (MAP) or a Gateway Foreign Agent (GFA), to thereby perform address translations between an Access Router address, that is, a Local Care-of Address (LCoA), and a global address for the other regions, that is, a Regional Care-of Address (RCoA).

Referring to FIG. 2, a mobile node MN has a session established with a correspondent node CN through a path 1. If a handoff occurs with the mobile node MN, the mobile node MN is assigned a new temporary address of CoA, and requests resource reservation re-establishment due to the change of its path. In this case, resources are generally re-established for end-to-end points, that is, from the mobile node MN to the correspondent node CN. However, a time delay occurs for the resource re-establishment, so that the mobile node MN is not properly provided with the QoS. When a handoff occurs in the RSVP-MP, the mobility proxy (MP) placed at the MAP/GFA translates the LCoA of an access network into the global address RCoA to be used from the MAP/GFA to the correspondent node CN, so that it is not needed to re-establish the RSVP session from the MAP/GFA to the correspondent node CN, but from the mobile node MN to the MAP/GFA. As a result, the RSVP-MP does not require resource reservation re-establishment for end-to-end points, thereby reducing a time delay due to the re-establishment of an RSVP session.

Even though the RSVP-MP does not require resource reservation re-establishment for end-to-end points, a time delay occurs by one round-trip time in order to establish the resource reservation, and the RSVP-MP does not rapidly release the resource reservation established through a previous access router, so that it still has a double resource reservation problem. Further, in case of frequent handoffs, the RSVP-MP has less occasions interfering with resource use than the MRSVP for new communication sessions due to the maintenance of double resource reservations for communication sessions, but still has a problem of such occasions. Furthermore, the RSVP-MP cannot be an independent protocol since it must be implemented together with the hierarchical mobility management scheme of MIP, and the RSVP-MP may be changed in its future implementation since the hierarchical mobility management scheme is not completed.

FIG. 3 is a view for showing the RSVP path extension through a pseudo reservation path and the path extension using the optimization reservation path according to the conventional concatenating and optimizing resource reservation path (CORP).

Referring to FIG. 3, the CORP uses the existing RSVP path extension process in case of handoffs to provide the QoS. At this time, the CORP uses the Concatenation for Reservation Path (CRP) process to extend a RSVP path.

The CRP process uses the Pseudo Reservation Path (PRP) process to extend the RSVP path, which establishes one central base station (BS) of BSes managed by one access router and reserves resources of neighboring BSes in advance. In case that a mobile node's handoff occurs, the BS managing a cell at which the mobile node MN arrives sends a CRP inform message to the BSes of neighboring cells to inform the BSes that the mobile node MN arrives so that the neighboring cells reserve resources in advance (PRP). The continuous extensions of the RSVP path by such a CRP process can create an infinite path or a loop path, so that the CORP uses the Optimization for Reservation Path (ORP) process together with the CRP process in order to prevent the creations of the infinite path or the loop path. The ORP process uses the CRP process and establishes a new RSVP session with a correspondent node CN when the mobile node MN moves to a different access router, to thereby solve a problem of path extensions and guarantee the QoS.

However, as aforementioned, the CORP reserves in advance the resources of neighboring cells to which the mobile node MN moves in the resource-insufficient mobile environments and, at the same time, establishes end-to-end RSVP sessions, which causes a problem of inefficiently wasting resources at an access network. Further, the CORP uses the multicast process when establishing a new session through a path extension and sets up a new RSVP session from a new access router to a correspondent node CN every time the mobile node MN moves to a different access router, which brings out a problem of scalability. Furthermore, the CORP is provided with more functions for releasing previous reservation resources compared to the MRSVP, but does not rapidly release the reservation resources since the CORP includes the release of the existing reservation resources up to the correspondent node CN, which can cause interference with a new session establishment for a different terminal.

### SUMMARY OF THE INVENTION

The present invention has been devised to solve the above problems, although solving one or more of the above-identified problems is not a requirement of the invention. It is an exemplary aspect of the present invention to provide a resource reservation system and method for solving a double resource reservation problem, a resource-wasting problem occurring due to excessive advance resource reservations, and a resource reservation re-establishment delay problem.

In order to achieve the above aspect, in a resource reservation system for mobile network environments having a mobile node, routers for intermediating communications between the mobile node and a correspondent node belonging to another network, and plural neighboring routers geographically adjacent to the router, a resource reservation system according to an illustrative embodiment of the present invention comprises a manager for sending a path request message for establishing a new path to the plural neighboring routers if a Fast resource REservation and rElease (FREE) initiation message is received from the mobile node in a case that the mobile node as a receiver performs a handoff, wherein, if the mobile node arrives in any of the communication ranges of the plural neighboring routers, the manager establishes a new path between the mobile node and the manager through the neighboring router for the communication range according to the sent path request message.

Preferably, but not necessarily, the neighboring router for the communication range pre-reserves resources to the manager in correspondence to the path request message, the mobile node sends a Binding Update (BU) message to the manager through the neighboring router for the communication range after the handoff, and the manager receives the BU message and, at the same time, sets up the new path. The advance reservations by the neighboring router for the communication range are performed within a transmission time interval established for the path request message.

Preferably, but not necessarily, if the advance resource reservations are not established by the neighboring router for the communication range within the transmission time interval, the neighboring router sends the received path request message to the mobile node, the mobile node sends the BU message and a reservation message to the manager through the neighboring router for the communication range, and the manager receives the BU message and the reservation message and, at the same time, establishes the new path. Further, the manager receives the BU message and, at the same time, releases a path between the router and the manager. Herein, the manager is preferably, but not necessarily, installed as a module in a different router capable of communicating with the router and the plural neighboring routers respectively.

In the meantime, in a resource reservation method for mobile network environments having a mobile node, a router for intermediating communications between the mobile node and a correspondent node belonging to another network, and plural neighboring routers geographically adjacent to the router, a resource reservation method according to an illustrative embodiment of the present invention comprises steps of sending a FREE initiation message from the mobile node to a manager managing resource reservations and releases if the mobile node as a receiver performs a handoff; sending from the manager to the plural neighboring routers a path request message for establishing a new path corresponding to the FREE initiation message; and establishing by the manager, if the mobile node arrives in a communication range of any of the plural neighboring routers, the new path between the mobile node and the manager through the neighboring router for the communication range according to the sent path request message.

Preferably, but not necessarily, the resource reservation method further comprises steps of pre-reserving resources by the neighboring router for the communication range based on the path request message; and sending a BU message from the mobile node to the manager through the neighboring router for the communication range, wherein the manager receives the BU message and, at the same time, establishes the new path.

At this time, the advance reservation step is preferably, but not necessarily, performed within a transmission time interval established for the path request message.

Further, it is preferable, but not necessary, that the resource reservation method further comprises steps of sending the path request message to the mobile node from the neighboring router for the communication range if the advance resource reservations are not established by the neighboring router for the communication range within the transmission time interval; and sending the BU message and a reservation message from the mobile node to the manager through the neighboring router for the communication range. At this time, preferably, but not necessarily, the manager receives the sent BU message and reservation message and, at the same time, establishes the new path.

Preferably, but not necessarily, the resource reservation method further comprises steps of sending a path release message and a reverse resource release message, corresponding to the sent BU message, from the manager to the router; and releasing a path between the router and the manager by the path release message and the reverse resource release message.

In a resource reservation system for mobile network environments having a mobile node, a router for intermediating communications between the mobile node and a correspondent node belonging to another network, and plural neighboring routers geographically adjacent to the router, a resource reservation system according to another illustrative embodiment of the present invention comprises a manager for sending a FREE initiation message to the plural neighboring routers if the mobile node as a transmitter performs a handoff and the FREE initiation message is received from the mobile node. The plural neighboring routers send a path request message, in response to the sent FREE initiation message, to the manager and, if the mobile node arrives in a communication range of any of the plural neighboring routers, the manager establishes a new path between the mobile node and the manager through the neighboring router for the communication range according to the sent path request message.

Herein, the manager pre-reserves resources to the router for the communication range based on the path request message, the mobile node sends a BU message to the manager through the neighboring router for the communication range after the handoff, and the manager receives the BU message and, at the same time, establishes the new path. Further, the advance reservations by the manager are established within a transmission time interval established for the path request message.

If the advance reservations are not established by the manager within the transmission time interval, the mobile node sends the BU message and a path message to the manager through the neighboring router for the communication range, and the manager preferably, but not necessarily, receives the BU message and the path message and, at the same time, establishes the path.

Further, the manager preferably, but not necessarily, releases a path between the router and the manager in response to the BU message.

In a resource reservation method for mobile network environments having a mobile node, a router for intermediating communications between the mobile node and a correspondent node belonging to another network, and plural neighboring routers geographically adjacent to the router, a resource reservation method according to another illustrative embodiment of the present invention comprises steps of sending a FREE initiation message from the mobile node to the plural neighboring routers through the router and a manager managing resource reservations and releases if the mobile node as a transmitter performs a handoff; sending from the plural neighboring routers to the manager a path request message for establishing a new path in correspondence to the sent FREE initiation message; and establishing by the manager, if the mobile node arrives in a communication range of any of the plural neighboring routers, the new path between the mobile node and the manager through the neighboring router for the communication range according to the sent path request message.

Preferably, but not necessarily, the resource reservation method according to another illustrative embodiment of the present invention further comprises steps of pre-reserving resources to the router for the communication range by the manager based on the path request message; and sending a BU message from the mobile node to the manager through the neighboring router for the communication range. The manager preferably, but not necessarily, receives the BU message and, at the same time, establishes the new path. Further, the advance reservation step is preferably, but not necessarily, performed within a transmission time interval established for the path request message.

Preferably, but not necessarily, the resource reservation method further comprises a step of sending the BU message and a path message through the neighboring router for the communication range from the mobile node to the manager if the advance resource reservations are not established by the manager within the transmission time interval. The manager preferably, but not necessarily, receives the sent BU message and path message and, at the same time, establishes the new path.

Further, preferably, but not necessarily, the resource reservation method further comprises steps of sending a reverse path release message and a resource release message to the router at the same time the manager receives the BU message; and releasing a path between the router and the manager by the reverse path release message and the resource release message.

Accordingly, in a case that a mobile node's handoff occurs, the resource reservation system for mobile network environments not only establishes only a new path between the manager and the mobile node so that rapid advance reservation and resource establishment are accomplished within a certain time, but also rapidly releases the existing resources after the handoff so as to solve a double resource reservation problem and a resource-wasting problem occurring due to the advance reservation of excessive resources.

### BRIEF DESCRIPTION OF THE DRAWINGS

The above exemplary aspect and other features of the present invention will become more apparent by describing in detail illustrative, non-limiting embodiments thereof with reference to the attached drawings, and wherein:

FIG. 1 is a view for showing a path pre-establishing resources according to the conventional MRSVP;

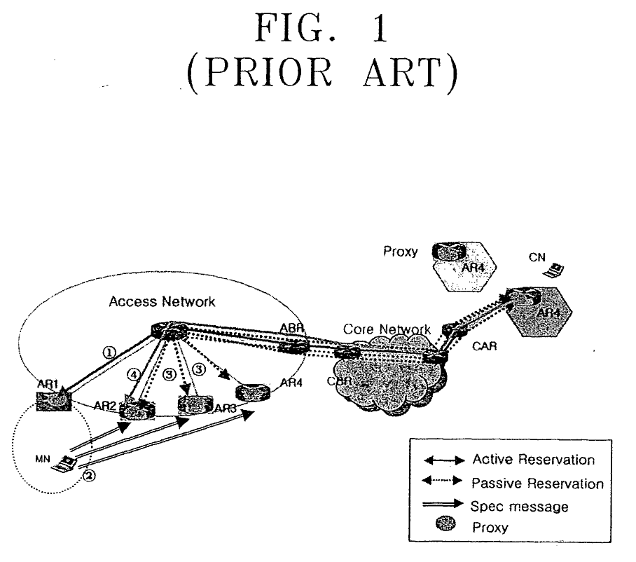

FIG. 2 is a view for showing a path establishing new resources through an address translation scheme based on the conventional RSVP-MP;

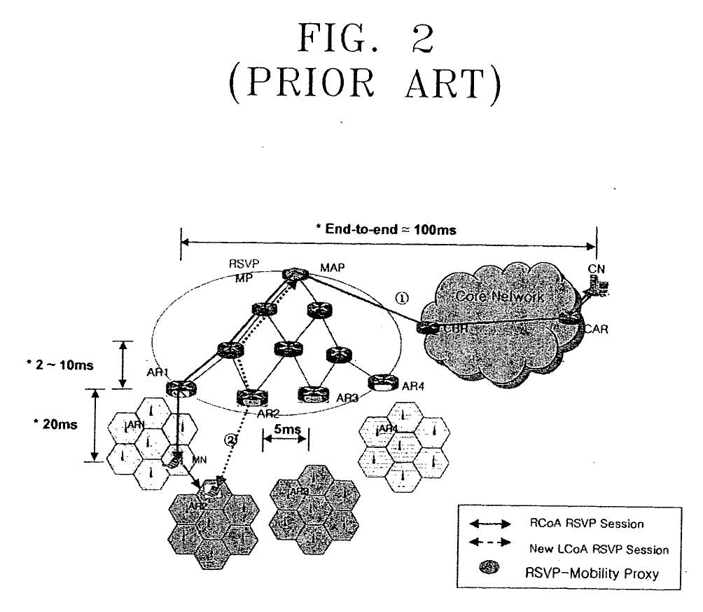

FIG. 3 is a view for showing a path extension in use of an RSVP path extension through a pseudo reservation path and an optimization reservation path according to the conventional CORP;

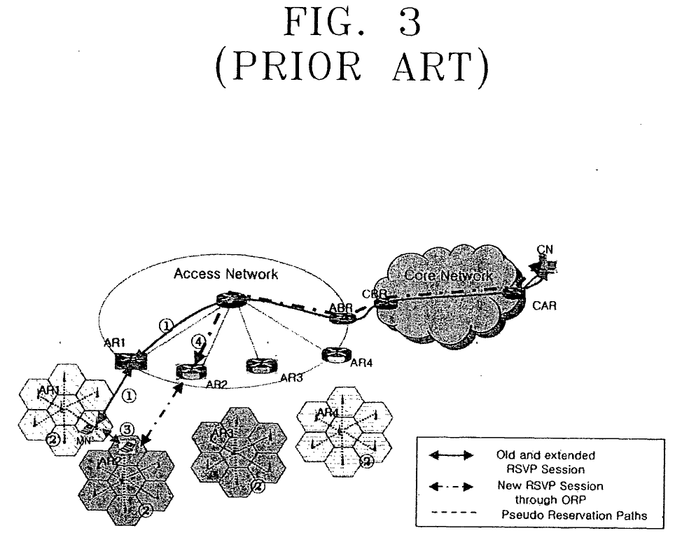

FIG. 4 is a view for explaining a resource release request to a router and a resource reservation request to a neighboring router when a handoff occurs with a mobile node as a receiver of a resource reservation system according to an illustrative embodiment of the present invention;

FIG. 5 is a view for explaining the establishment of a new path and the release of an existing path after a handoff occurs with a mobile node as a receiver of a resource reservation system according to an illustrative embodiment of the present invention;

FIG. 6 is a view for explaining transmission time intervals for a path request message when the handoff occurs with a mobile node in FIG. 4 and FIG. 5;

FIG. 7 is a flow chart for showing a resource reservation method for the resource reservation system of FIG. 4 and FIG. 5;

FIG. 8 is a view for showing signal flows in a case that resources are pre-reserved in the resource reservation system of FIG. 4;

FIG. 9 is a view for showing signal flows in a case that resources are not pre-reserved in the resource reservation system of FIG. 5;

FIG. 10 is a view for explaining a resource release request to a router and a resource reservation request from a neighboring router when a handoff occurs with a mobile node as a transmitter of a resource reservation system according to an illustrative embodiment of the present invention;

FIG. 11 is a view for explaining the establishment of a new path and the release of an existing path after a handoff occurs with a mobile node as a transmitter of a resource reservation system according to an illustrative embodiment of the present invention;

FIG. 12 is a flow chart for showing a resource reservation method for the resource reservation system of FIG. 10 and FIG. 11;

FIG. 13 is a view for showing signal flows in a case that resources are pre-reserved in the resource reservation system of FIG. 10; and

FIG. 14 is a view for showing signal flows in a case that resources are not pre-reserved in the resource reservation system of FIG. 11.

### DETAILED DESCRIPTION OF THE PREFERRED EMBODIMENTS

Hereinafter, the present invention will be described in detail with reference to the accompanying drawings.

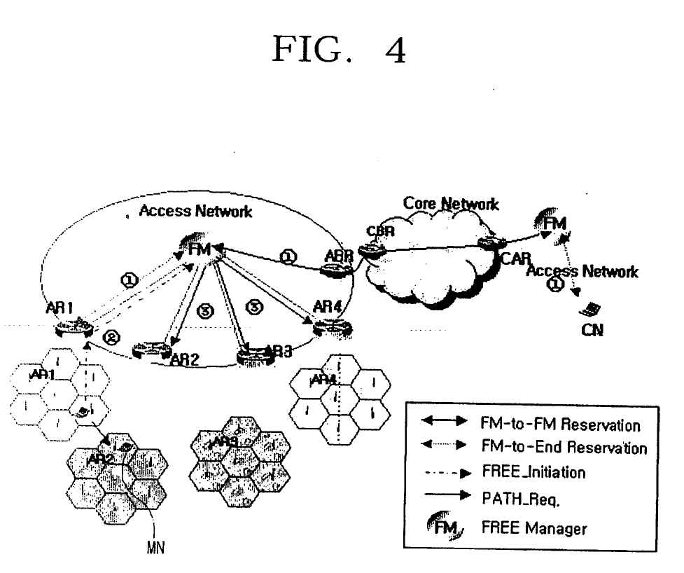

FIG. 4 is a view for explaining a resource release request to a router and a resource reservation request to a neighboring router when a handoff occurs with a mobile node as a receiver of a resource reservation system according to an illustrative embodiment of the present invention.

Referring to FIG. 4, a resource reservation system has a mobile node MN, plural access routers ARs, and managers. The plural access routers ARs are classified into a router AR1 intermediating current communications between a correspondent node CN belonging to another network and the mobile node MN, plural neighboring routers AR2, AR3, and AR4 geographically adjacent to the router AR1, and an access border router (ABR) intermediating communications between another network and a manager FM.

The manager FM manages resource reservations and releases in an access network, and its full name is a Fast resource REservation and rElease (FREE) manager (hereinafter, referred to as a manager FM).

The mobile node MN communicates with the correspondent node CN through a path numbered 1, and, at this time, the router AR1 intermediates communications between the mobile node MN and the correspondent node CN. In a case that the mobile node MN as a receiver performs a handoff, the mobile node MN sends a FREE initiation message to the manager FM through the router AR1 (number 2). The FREE initiation message includes a message notifying of the initiation of a handoff of the mobile node MN in order to reserve resources according to the present invention. The manager FM sends to the plural neighboring routers AR2, AR3, and AR4 a path request message for establishing a new path if the FREE initiation message is received from the mobile node MN (number 3). The plural neighboring routers AR2, AR3, and AR4 reserve resources in advance to the manager FM in response to the received path request message.

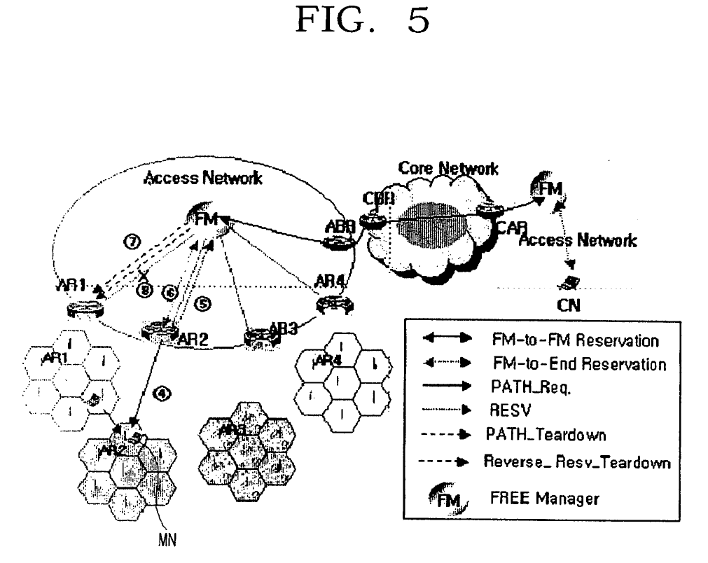

FIG. 5 is a view for explaining the establishment of a new path and the release of an existing path after a handoff occurs with a mobile node as a receiver of a resource reservation system according to an illustrative embodiment of the present invention.

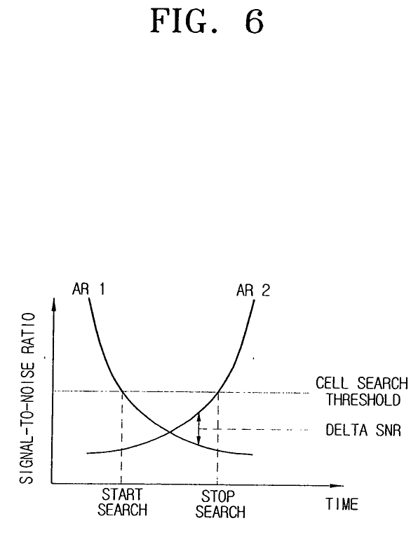

Referring to FIG. 5, when the mobile node M as a receiver arrives in a communication range of the neighboring router AR2 after the handoff of the mobile node MN, the manager FM confirms the establishment of a new path between the mobile node MN and the manager FM through the neighboring router AR2. Herein, if the neighboring routers AR2, AR3, and AR4 pre-reserve resources by a path request message, the manager FM sets up a path between the mobile node MN and the manager FM by a Binding Update (BU) message sent from the mobile node MN through the neighboring router AR2. At this time, the time when the resources are pre-reserved by the neighboring routers AR2, AR3, and AR4 is determined by a signal-to-noise ratio (SNR) signal, which is shown in FIG. 6. That is, if a SNR signal between the mobile node MN and the router AR1 comes below a threshold value when the mobile node MN as a receiver performs a handoff, the mobile node MN sends the FREE initiation message to the manager FM through the router AR1. As the mobile node MN approaches the communication range of the neighboring router AR2, the SNR signal between the mobile node MN and the neighboring router AR2 increases. If the SNR signal between the mobile node MN and the neighboring router AR2 exceeds the threshold value, the mobile node MN performs a handoff from the router AR1 to the neighboring router AR2, and the time interval between the switchover threshold values at this time becomes a delay time. A transmission time interval for sending a path request message is pre-set to a certain value in consideration of a handoff delay time, and it is preferable that advance resource reservations by the neighboring routers AR2, AR3, and AR4 are performed within the transmission time interval for the path request message.

If the mobile node MN and the neighboring router AR2 in the communication range do not reserve resources in advance within the transmission time interval for the path request message, the neighboring router AR2 sends to the mobile node MN a path request message received from the manager FM (number 4). The mobile node MN sends a BU message and a reservation message to the manager FM through the neighboring router AR2 in response to the path request message sent from the neighboring router AR2 (number 5). The manager FM receives the BU message and reservation message sent from the mobile node MN and, at the same time, establishes a new path between the neighboring router AR2 and the manager FM (number 6).

In the meantime, the manager FM receives the BU message and reservation message sent from the mobile node MN, and, at the same time, sends a path release message Path_Teardown and a reverse resource release message Reverse_Resv_Teardown to the router AR1 (number 7). A path between the router AR1 and the manager FM is released by the sent path release message and reverse resource release message (number 8). The path release message is so named because the manager FM releases a path between the router AR1 and the manager FM that is established by the resource reservation of the router AR1, and the reverse resource release message is so named because the manager FM releases registered resources by the resource reservations of the router AR1 in the opposite direction to the resource reservation message.

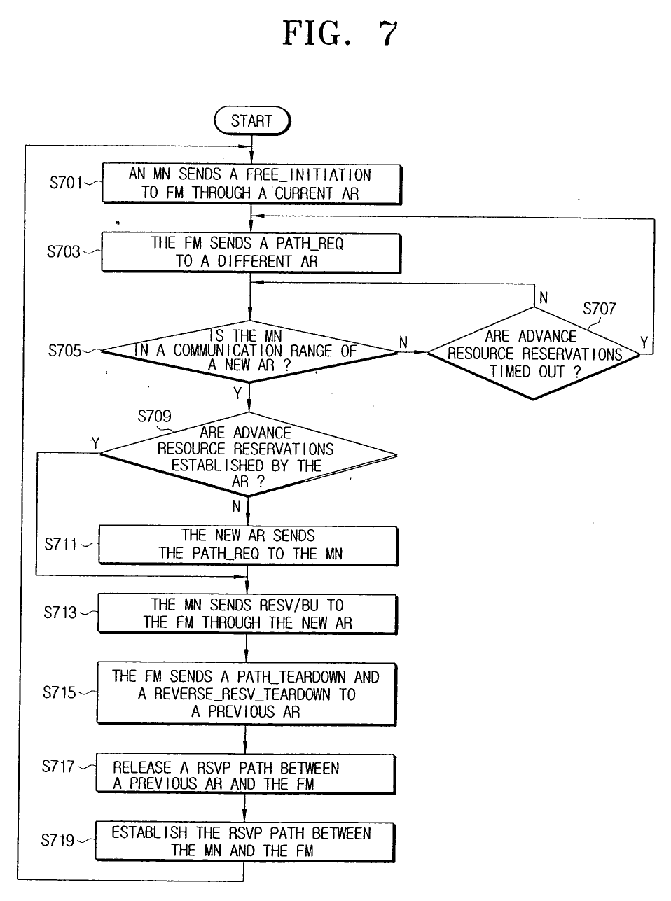

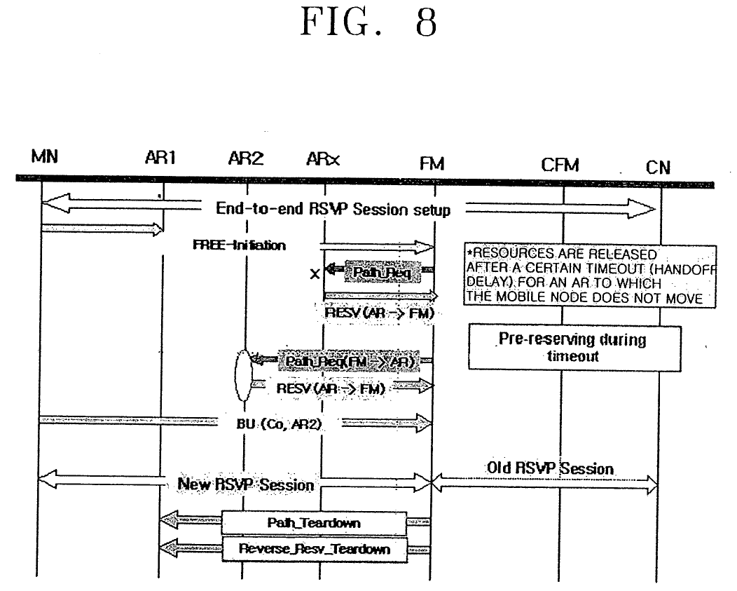

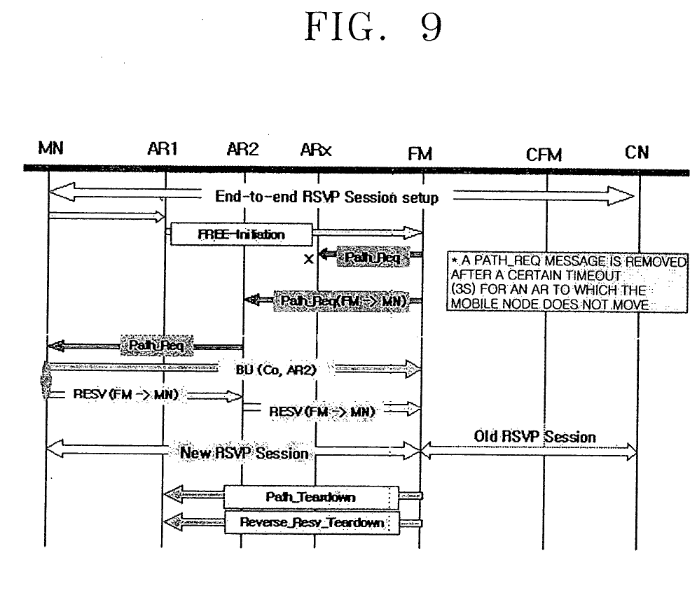

FIG. 7 is a flow chart for showing a resource reservation method for the resource reservation system of FIG. 4 and FIG. 5, and FIG. 8 is a view for showing signal flows in a case that resources are pre-reserved in the resource reservation system of FIG. 4, and FIG. 9 is a view for showing signal flows in a case that resources are not pre-reserved in the resource reservation system of FIG. 5. Referring to FIGS. 7, 8, and 9, a resource reservation method according to an illustrative embodiment of the present invention will be described in detail.

If the mobile node MN in the communication range of the router AR1 performs a handoff to a new cell from a communication range of the router AR1, the mobile node MN sends the FREE initiation message to the manager FM through the router AR1 (S701). If the FREE initiation message is received from the mobile node MN, the manager FM sends to the neighboring routers AR2, AR3, and AR4 a path request message for advance resource reservations (S703).

The neighboring routers AR2, AR3, and AR4 decide whether the mobile node MN arrives in their communication ranges (S705). The decision on whether the mobile node MN arrives in the communication ranges of the neighboring routers AR2, AR3, and AR4 is performed by using an SNR signal between the mobile node MN and the neighboring routers AR2, AR3, and AR4, which is the same as set forth above. If the mobile node MN does not arrive in the communication ranges of the neighboring routers AR2, AR3, and AR4 within a time interval for advance resource reservations, that is, within the transmission time interval for the path request message, it is preferably, but not necessarily, implemented for the manager FM to re-send the path request message to the neighboring routers AR2, AR3, and AR4 (S707). The re-sending of the path request message by the manager FM is preferably, but not necessarily, implemented within the established transmission time interval for the path request message, which is for preventing the waste of resources due to advance reservations excessively established between the manager FM and the neighboring routers AR2, AR3, and AR4.

If the mobile node MN arrives in the communication range of the neighboring router AR2 and the neighboring router AR2 does not pre-reserve resources within the time when a handoff is completed (S709), the neighboring router AR2 in the communication range of the mobile node MN sends to the mobile node MN the path request message received from the manager FM to attempt resource reservations (S711).

If the path request message is received from the neighboring router AR2, the mobile node MN sends a reservation message and a BU message to the manager FM through the neighboring router AR2 in the communication range to notify the manager FM of location registration information on the mobile node MN (S713).

If the mobile node MN arrives in the communication range of the neighboring router AR2 and the neighboring router AR2 pre-reserves resources by the path request message received from the manager FM (S709), the mobile node MN sends only the BU message to the manager FM through the neighboring router AR2. The BU message is information notifying the manager FM of the handoff of the mobile node MN, and includes information on a CoA newly assigned by the neighboring router AR2. At this time, as for the neighboring routers AR3 and AR4 in the communication ranges in which the mobile node MN does not arrive, even though resources are pre-reserved by the received path request message, the pre-reserved resources are automatically released when a time interval for the advance reservations ends, which is for preventing an occasion that resources are excessively reserved in advance. FIG. 8 and FIG. 9 show signal flows for an occasion that resources are pre-reserved by the neighboring router AR2 and for an occasion that resources are not pre-reserved by the same, respectively.

If the manager FM receives the BU message from the mobile node MN, the manager FM sends the path release message and the reverse resource release message to a previous access router, that is, the router AR1 (S715). Thus, a previous communication path for the mobile node MN, that is, an RSVP path between the mobile node MN and the manager FM through the router AR1 is released (S717). The manager FM re-sends the path request message to the neighboring routers AR2, AR3, and AR4 for resource reservations if a reservation message is not received from the mobile node MN through the neighboring router AR2. This is for compensating for a drawback that the mobile node MN is not provided with the QoS after its handoff due to a handoff delay.

Further, the manager FM establishes a new RSVP path between the mobile node MN and the manager FM through the neighboring router AR2 when receiving the reservation message (S719).

Thus, the manager FM receives the reservation message and the BU message at the same time, sets up the new RSVP path, and releases a previous RSVP path, so that an occasion of double resource reservations can be prevented.

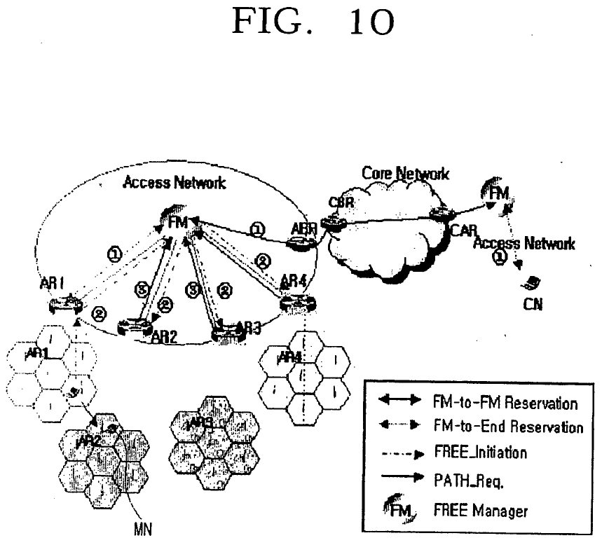

FIG. 10 is a view for explaining a resource release request to a router and a resource reservation request by a neighboring router if a handoff is performed with a mobile node as a transmitter of the resource reservation system according to an illustrative embodiment of the present invention.

The description on a structure of the resource reservation system will be skipped since the structure is the same as above. Referring to FIG. 10, the mobile node MN communicates with a correspondent node CN through a path numbered 1, and, at this time, the router AR1 intermediates communications between the mobile node MN and the correspondent node CN. If the mobile node MN as a transmitter performs a handoff, the mobile node MN sends a FREE initiation message to the neighboring routers AR2, AR3, and AR4 through the router AR1 and the manager FM (number 2). The neighboring routers AR2, AR3, and AR4 send a path request message to the manager FM to set up a new path if a FREE initiation message is received from the mobile node MN (number 3). The manager FM pre-reserves resources to the neighboring routers AR2, AR3, and AR4 in response to the received path request message.

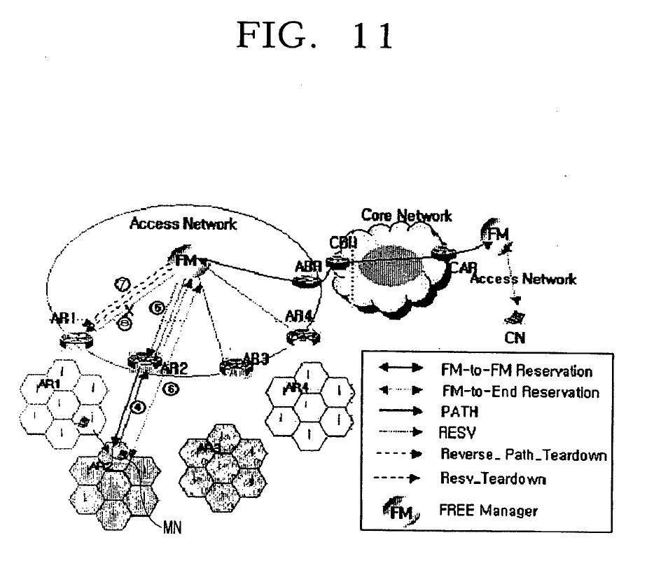

FIG. 11 is a view for explaining the establishment of a new path and the release of an existing path after a handoff is performed with the mobile node as a transmitter of the resource reservation system according to the present invention.

Referring to FIG. 11, if the mobile node MN as a transmitter performs a handoff and then arrives in the communication range of the neighboring router AR2, the manager FM establishes a new path between the mobile node MN and the manager FM through the neighboring router AR2 in the communication range according to the received path request message. If the manager FM pre-reserves resources by the path request message, the manager FM sets up a path between the mobile node MN and the manager FM by the BU message sent from the mobile node MN through the neighboring router AR2. At this time, the time when resources are pre-reserved by the neighboring routers AR2, AR3, and AR4 is decided by the SNR signal, and performed in the same manner as described above.

If the manager FM does not pre-reserve resources to the neighboring router AR2 within a transmission time interval for the path request message sent from the neighboring router AR2, the mobile node MN sends the BU message and the path message to the manager FM through the neighboring router AR2 (number 4). The path message includes location movement information on the mobile node MN. The manager FM reserves resources to the neighboring router AR2 by the BU message and the path message sent from the mobile node MN (number 5). Further, the manager FM receives the BU message and the path message sent from the mobile node MN and, at the same time, establishes a new path between the mobile node MN and the manager FM through the neighboring router AR2 (number 6).

In the meantime, the manager receives the BU message sent from the mobile node MN and, at the same time, sends the reverse path release message Reverse_Path_Teardown and the resource release message Resv_Teardown to the router AR1 (number 7). The path between the router AR1 and the manager FM is released by the sent reverse path release message and resource release message (number 8). The reverse path release message is so named because the manager FM releases the path between the router AR1 and the manager FM that is set up in the opposite direction to the path reservation message by the resource reservations of the manager FM, and the resource release message is so named because the router AR1 releases registered resources by the resource reservations of the manager FM.

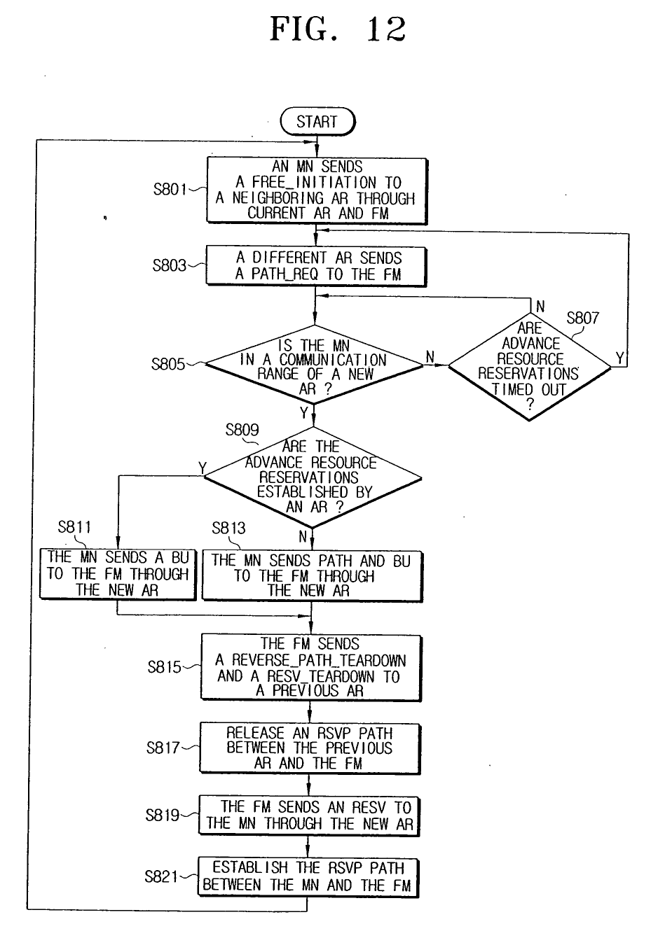

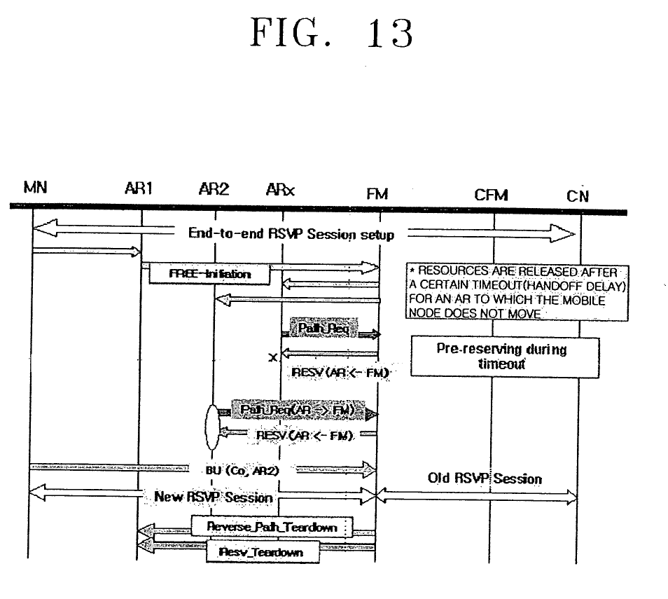

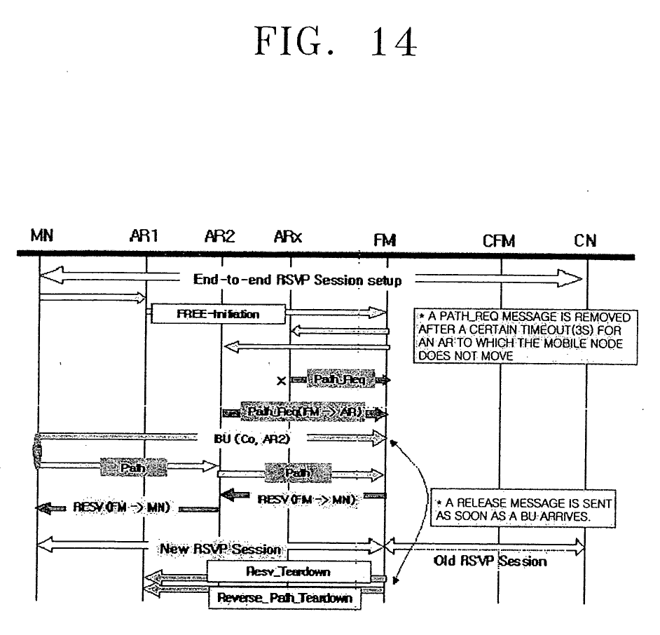

FIG. 12 is a flow chart for showing a resource reservation method for the resource reservation system of FIG. 10 and FIG. 11, FIG. 13 is a view for showing signal flows in a case that resources are pre-reserved in the resource reservation system of FIG. 10, and FIG. 14 is a view for showing signal flows in a case that resources are not pre-reserved in the resource reservation system of FIG. 11. Referring to FIGS. 12, 13, and 14, the resource reservation method according to an illustrative embodiment of the present invention will be described in detail.

If the mobile node MN as a transmitter in the communication range of the router AR1 initiates a handoff to a new cell from the communication range of the router AR1, the mobile node MN sends the FREE initiation message to the neighboring routers AR2, AR3, and AR4 through the router AR1 and the manager FM (S801). If the FREE initiation message is received from the mobile node MN, the neighboring routers AR2, AR3, and AR4 send to the manager FM the path request message for advance resource reservations (S803).

The neighboring routers AR2, AR3, and AR4 decide whether the mobile node MN arrives in their communication ranges (S805). The decision on whether the mobile node MN arrives in the communication ranges of the neighboring routers AR2, AR3, and AR4 is performed by use of the SNR signal between the mobile node MN and the neighboring routers AR2, AR3, and AR4, which is the same as described above. If the mobile node MN does not arrive in the communication ranges of the neighboring routers AR2, AR3, and AR4 within a time interval for advance resource reservations, that is, within the transmission time interval for the path request message, it is preferably, but not necessarily, implemented for the neighboring routers AR2, AR3, and AR4 to re-send the path request message to the manager FM (S807). The re-sending of the path request message by the neighboring routers AR2, AR3, and AR4 is preferably, but not necessarily, implemented only within the established transmission time interval for the path request message, which prevents the waste of resources due to advance reservations excessively established between the manager FM and the neighboring routers AR2, AR3, and AR4.

If the manager FM pre-reserves resources to the neighboring router AR2, the mobile node MN arrived in the communication range of the neighboring router AR2 sends the BU message to the manager FM through the neighboring router AR2 (S811).

If the mobile node MN arrives in the communication range of the neighboring router AR2 and the manager FM does not pre-reserve resources to the neighboring router AR2 within the time for which a handoff is completed (S809), the mobile node MN sends the path message and the BU message to the manager FM through the neighboring router AR2 to attempt the resource reservations (S813).

The manager FM receives the BU message from the mobile node MN and, at the same time, sends the reverse path release message and the resource release message to the neighboring router AR1 (S815). The RSVP path between the router AR1 and the manager FM is released by the reverse path release message and the resource release message (S817).

Further, the manager FM receives the path message and the BU message from the mobile node MN and, at the same time, reserves resources to the mobile node MN through the neighboring router AR2 (S819). A new RSVP path is established between the manager FM and the mobile node MN through the neighboring router AR2 by the resources reserved by the manager FM (S821).

Accordingly, even in a case that the mobile node MN is a transmitter, the establishment of a new RSVP path and the release of a previous RSVP path are smoothly performed, so that the occasions of double resource reservations can be prevented.

The resource reservation system according to illustrative embodiments of the present invention sets up new RSVP paths only in an access network through the FREE manager, by which a load occurring when intermediate routers in another network manage RSVP sessions can be reduced.

Further, the resource reservation system can mitigate a problem of poor QoS for the mobile node MN, that is, a problem of delaying the QoS re-establishment since a new RSVP path is established between the mobile node MN and the manager FM and resources are rapidly established by use of the Fast resource Reservation Setup (FRS), differently from the existing RSVP-MP, when the mobile node MN performs a handoff.

Furthermore, the resource reservation system minimizes the call blocking possibility due to a problem of double resource reservations compared to the existing MRSVP, RSVP-MP, and CORP since it rapidly removes a previous RSVP path through the manager FM.

Further still, the resource reservation system pre-reserves resources during a handoff delay, and has the manager FM send a resource establishment message to the neighboring routers AR2, AR3, and AR4 for resource reservation preparation if the neighboring routers AR2, AR3, and AR4 do not pre-reserve resources during the handoff, by which a problem of excessive resource reservations occurring in the MRSVP or CORP is solved so that the efficient utilization of wireless resources is accomplished.

Although illustrative embodiments of the present invention have been described, it will be understood by those skilled in the art that the present invention should not be limited to the described embodiments, but various changes and modifications can be made within the spirit and scope of the present invention as defined by the appended claims.

What is claimed is:

1. A resource reservation system for mobile network environments having a mobile node, a router for intermediating communications between the mobile node in a first network and a correspondent node in a second network, and a plurality of neighboring routers geographically adjacent to the router, the system comprising:
a manager for sending a path request message for establishing a new path to the neighboring routers if a fast resource reservation and release (FREE) initiation message is received from the mobile node, if the mobile node as a receiver performs a handoff,
wherein, if the mobile node arrives in a communication range of any of the neighboring routers, the manager establishes a new path between the mobile node and the manager, through the neighboring router corresponding to the communication range, according to the sent path request message.

2. The resource reservation system as claimed in claim 1, wherein the neighboring router corresponding to the communication range pre-reserves resources to the manager in response to the path request message, the mobile node sends a Binding Update (BU) message to the manager through the neighboring router corresponding to the communication range after the handoff, and the manager receives the BU message and sets up the new path.

3. The resource reservation system of claim 2, wherein the manager sets up the new path at the same time that the BU message is received.

4. The resource reservation system as claimed in claim 2, wherein the pre-reservation of resources by the neighboring router corresponding to the communication range is performed within a transmission time interval established for the path request message.

5. The resource reservation system as claimed in claim 4, wherein, if the pre-reservation of resources is not established by the neighboring router corresponding to the communication range within the transmission time interval, the neighboring router sends the path request message received from the manager to the mobile node, the mobile node sends the BU message and a reservation message to the manager through the neighboring router corresponding to the communication range, and the manager receives the BU message and the reservation message and establishes the new path.

6. The resource reservation system as claimed in claim 5, wherein the manager establishes the new path at the same time that the manager receives the BU message and the reservation message.

7. The resource reservation system as claimed in claim 5, wherein the manager receives the BU message and releases a path between the router and the manager.

8. The resource reservation system as claimed in claim 7, wherein the manager releases the path between the router and the manager at the same time that the manager receives the BU message.

9. The resource reservation system as claimed in claim 7, wherein the manager is installed as a module in a different router capable of communicating with the router and the neighboring routers.

10. A resource reservation method for mobile network environments having a mobile node, a router for intermediating communications between the mobile node in a first network and a correspondent node in a second network, and a plurality of neighboring routers geographically adjacent to the router, comprising:
sending a fast resource reservation and release (FREE) initiation message from the mobile node to a manager managing resource reservations and releases, if the mobile node as a receiver performs a handoff;
sending from the manager to the neighboring routers a path request message for establishing a new path in response to the FREE initiation message; and
establishing by the manager, if the mobile node arrives in a communication range of any of the neighboring routers, the new path between the mobile node and the manager, through the neighboring router corresponding to the communication range, according to the sent path request message.

11. The resource reservation method as claimed in claim 10, further comprising:
pre-reserving resources by the neighboring router corresponding to the communication range in response to the path request message; and
sending a BU message from the mobile node to the manager through the neighboring router corresponding to the communication range, wherein the manager receives the BU message and establishes the new path.

12. The resource reservation method as claimed in claim 11, wherein the manager establishes the new path at the same time that the manager receives the BU message.

13. The resource reservation method as claimed in claim 11, wherein the pre-reserving of resources is performed within a transmission time interval established for the path request message.

14. The resource reservation method as claimed in claim 13, further comprising:
sending the path request message to the mobile node from the neighboring router corresponding to the communication range if the pre-reserving of resources is not established by the neighboring router corresponding to the communication range within the transmission time interval; and
sending the BU message and a reservation message from the mobile node to the manager through the neighboring router corresponding to the communication range, wherein the manager receives the sent BU message and reservation message and establishes the new path.

15. The resource reservation method as claimed in claim 14, wherein the manager establishes the new path at the same time that the manager receives the BU message and the reservation message.

16. The resource reservation method as claimed in claim 14, further comprising:
sending a path release message and a reverse resource release message in response to the sent BU message from the manager to the router; and
releasing a path between the router and the manager by the path release message and the reverse resource release message.

17. The resource reservation method as claimed in claim 16, wherein the manager is installed as a module in a different router capable of communicating with the router and the neighboring routers.

18. A resource reservation system for mobile network environments having a mobile node, a router for intermediating communications between the mobile node in a first network and a correspondent node in a second network, and a plurality of neighboring routers geographically adjacent to the router, comprising a manager for sending a fast resource reservation and release (FREE) initiation message to the neighboring routers, if the mobile node as a transmitter performs a handoff and the FREE initiation message is received at the manager from the mobile node,
wherein the neighboring routers send a path request message to the manager in response to the sent FREE initiation message, and, if the mobile node arrives in a communication range of any of the neighboring routers, the manager establishes a new path between the mobile node and the manager, through the neighboring router corresponding to the communication range, according to the sent path request message.

19. The resource reservation system as claimed in claim 18, wherein the manager pre-reserves resources to the router corresponding to the communication range in response to the path request message, the mobile node sends a BU message to the manager through the neighboring router corresponding to the communication range after the handoff, and the manager receives the BU message and establishes the new path.

20. The resource reservation system as claimed in claim 19, wherein the manager establishes the new path at the same time that the manager receives the BU message.

21. The resource reservation system as claimed in claim 19, wherein the pre-reserving of resources by the manager is established within a transmission time interval established for the path request message.

22. The resource reservation system as claimed in claim 21, wherein, if the pre-reserving of resources is not established by the manager within the transmission time interval, the mobile node sends the BU message and a path message to the manager through the neighboring router corresponding to the communication range, and the manager receives the BU message and the path message and establishes the new path.

23. The resource reservation system as claimed in claim 22, wherein the manager establishes the new path at the same time that the manager receives the BU message and the path message.

24. The resource reservation system as claimed in claim 22, wherein the manager releases a path between the router and the manager in response to the BU message.

25. The resource reservation system as claimed in claim 24, wherein the manager is installed as a module in a different router capable of communicating with the router and the neighboring routers.

26. A resource reservation method for mobile network environments having a mobile node, a router for intermediating communications between the mobile node in a first network and a correspondent node in a second network, and a plurality of neighboring routers geographically adjacent to the router, comprising:
sending a fast resource reservation and release (FREE) initiation message from the mobile node to the neighboring routers through the router and a manager managing resource reservations and releases, if the mobile node as a transmitter performs a handoff;
sending from the neighboring routers to the manager a path request message for establishing a new path in response to the sent FREE initiation message; and
establishing by the manager, if the mobile node arrives in a communication range of any of the neighboring routers, the new path between the mobile node and the manager, through the neighboring router corresponding to the communication range, according to the sent path request message.

27. The resource reservation method as claimed in claim 26, further comprising:
pre-reserving resources to the router corresponding to the communication range by the manager in response to the path request message; and
sending a BU message from the mobile node to the manager through the neighboring router corresponding to the communication range, wherein the manager receives the BU message and establishes the new path.

28. The resource reservation method as claimed in claim 27, wherein the manager establishes the new path at the same time that the manager receives the BU message.

29. The resource reservation method as claimed in claim 27, wherein the pre-reserving of resources is performed within a transmission time interval established for the path request message.

30. The resource reservation method as claimed in claim 29, further comprising sending the BU message and a path message through the neighboring router corresponding to the communication range from the mobile node to the manager if the pre-reserving of resources is not established by the manager within the transmission time interval, wherein the manager receives the sent BU message and path message and establishes the new path.

31. The resource reservation method as claimed in claim 30, wherein the manager establishes the new path at the same time that the manager receives the BU message and the path message.

32. The resource reservation method as claimed in claim 30, further comprising:
sending a reverse path release message and a resource release message to the router in response to the received BU message; and
releasing a path between the router and the manager by the reverse path release message and the resource release message.

33. The resource reservation method as claimed in claim 32, wherein the path release message and the resource release message are sent to the router at the same time that the manager receives the BU message.

34. The resource reservation method as claimed in claim 32, wherein the manager is installed as a module in a different router capable of communicating with the router and the neighboring routers.
